(19) United States
(12) Patent Application Publication
(10) Pub. No.: US 2015/0177835 A1
(43) Pub. Date: Jun. 25, 2015

(54) SECONDARY SENSE COMMUNICATION SYSTEM AND METHOD

(71) Applicant: Marco R. Gazzetta, San Diego, CA (US)

(72) Inventor: Marco R. Gazzetta, San Diego, CA (US)

(21) Appl. No.: 14/184,665

(22) Filed: Feb. 19, 2014

Related U.S. Application Data
(60) Provisional application No. 61/920,452, filed on Dec. 23, 2013.

(51) Int. Cl. G06F 3/01

(52) U.S. Cl. CPC G06F 3/014

(57) ABSTRACT

A method of communicating with a computer includes the steps of receiving a coded input signal from a wearer of a glove, transmitting the coded input signal to a remote computer, converting the coded input signal into a machine readable text input signal, processing the machine readable text input and creating a machine readable text output signal, converting the human readable text output signal into a coded output signal, transmitting the coded output signal to the glove, and transmitting the coded output signal to the wearer of the glove.

### RELATED APPLICATION

This application claims priority to U.S. provisional patent application, entitled SECONDARY SENSE COMPUTER INTERFACE, Application No. 61/920,452 filed Dec. 23, 2013.

### FIELD OF THE INVENTION

The present invention relates in general to a system and method for providing a human-computer communication interface. It more particularly relates to a system and method for providing a more efficient human-computer interface that uses only a sense of touch for communication.

### BACKGROUND ART

This section describes the background art of the disclosed embodiment of the present invention. There is no intention, either express or implied, that the background art discussed in this section legally constitutes prior art.

Conventional human-computer interfaces rely on the primary senses of humans. In particular, the output communication from the computer to the human typically focuses on the senses of sight and hearing. Meanwhile, the input communication into computers typically occurs using the sense of touch e.g., keyboard, but also relies on secondary confirmation from the sense of sight.

Conventional techniques for some type of touch-based interface between a human and a computer have provided only a one-way communication channel. Further, the prior art systems typically provide for communication of data such as location data or a set of instructions for a mechanical device. For example, reference may be made to the following patents; European Patent Publication No. EP2624238; U.S. Patent Publication No. US 2013/0169420; U.S. Patent Publication No. US 2012/0157263; and U.S. Pat. No. 6,924,787.

Therefore, it would be highly desirable to have a new and improved method and system for providing a human-computer interface that relies exclusively on a sense of touch for full two-way communication between two humans.

### BRIEF DESCRIPTION OF THE DRAWINGS

In order to better understand the invention and to see how the same may be carried out in practice, non-limiting preferred embodiments will now be described with reference to the accompanying drawings, in which:

FIG. 1. is a pictorial view of a secondary sense communication system, which is constructed in accordance with an embodiment;

FIGS. 2A-B are perspective cut-away views of the glove interface assembly of FIG. 1;

FIG. 3 is a schematic diagram of the glove interface assembly of FIG. 1; and

FIGS. 4A-D are flow diagrams to illustrate the method for carrying out the secondary sense communication system of FIG. 1.

### CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of certain ones of the embodiments of the system, components and method of the present invention, as represented in the drawings, is not intended to limit the scope of the invention, as claimed, but is merely representative of the embodiment of the invention.

Computer interface systems and methods of using them to allow touch-enabled communication via a human-computer interface. The computer interface system includes a glove having one or more digit components each having an input activator for receiving a coded input signal from a wearer of the glove and an output activator for transmitting a coded output signal to the wearer of the glove, a control unit connected to each of the input activators and the output activators for receiving from the input activators and transmitting to a remote computer the coded input signal and for receiving from the remote computer and transmitting to the output activators the coded output signal, a power source connected to the control unit and each of the input activators and the output activators for providing power, such that the remote computer converts the coded input signal into a human readable text input signal and converts a human readable text output signal to the coded output signal for transmitting to the control unit.

According to certain embodiments of the communication system, the input activator is a button switch and the output activator is a vibration device. A wireless communication component may be employed for transmitting the coded input signal and receiving the coded output signal wirelessly.

A further embodiment relates to a method of communicating with a computer including the steps of receiving a coded input signal from a wearer of a glove, transmitting the coded input signal to a remote computer, converting the coded input signal into a machine readable text input signal, processing the machine readable text input and creating a machine readable text output signal, converting the human readable text output into a coded output signal, transmitting the coded output signal to the glove, and transmitting the coded output signal to the wearer of the glove.

According to certain embodiments of the method of communicating, the step of receiving a coded input signal from a wearer of a glove further includes receiving the signal via a button switch and the step of transmitting the coded output signal to the wearer of the glove further includes transmitting the signal via a vibration device. According to further embodiments of the method of communicating, the steps of transmitting the coded input signal to a remote computer and transmitting the coded output signal to the glove further include transmitting the signals wirelessly.

Yet a further embodiment relates to a method of communicating through a network including the steps of receiving a coded input signal from a wearer of a glove, transmitting the coded input signal to a remote computer, converting the coded input signal into a human readable text input signal, and transmitting the human readable text input signal to a third party via the network.

According to certain embodiments of the method of communicating, the step of receiving a coded input signal from a wearer of a glove further includes receiving the signal via a button switch. According to further embodiments of the method of communicating, the steps of transmitting the coded input signal to a remote computer includes transmitting the signals wirelessly.

A further embodiment relates to a method of communicating through a network including the steps of receiving a human readable text output signal from the third party via the network, converting the human readable text output signal into a coded output signal, transmitting the coded output signal to the glove, and transmitting the coded output signal to the wearer of the glove.

According to certain embodiments of the method of communicating, the step of transmitting the coded output signal to the wearer of the glove further includes transmitting the signal via a vibration device. According to further embodiments of the method of communicating, the steps of transmitting the coded output signal to the glove further include transmitting the signals wirelessly.

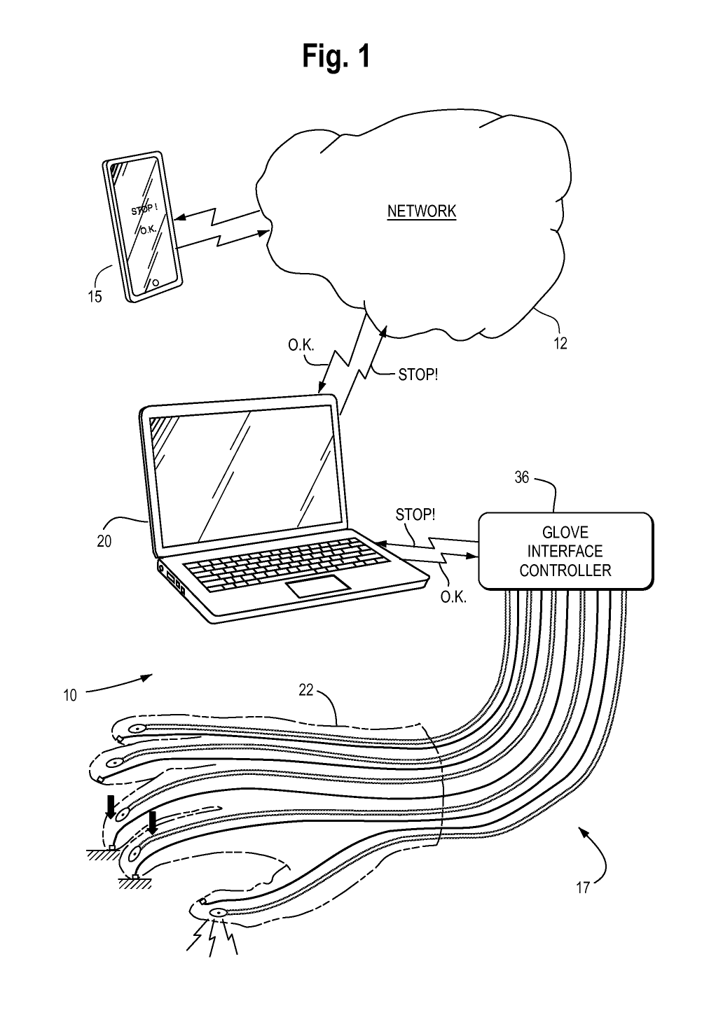

Referring now to FIG. 1 of the drawings, there is shown a secondary sense communication system 10, which is constructed in accordance with an embodiment. The secondary sense communication system 10 includes a glove interface assembly 17 for sending and receiving coded messages through a remote computer 20 that communicates with a remote communication device 15 through a network 12. The coded messages are input by a user via a series of input activators located on the digits of the glove interface assembly 17 and received by the user via a series of output activators also located on the digits.

An example of the secondary sense communication system and method of operation is also shown in FIG. 1. First, the user taps out a coded input message “Stop!” using the input activators on the glove interface assembly 17, which then transmit the coded input message to the remote computer 20. The remote computer 20 converts the coded input message into a human readable input message that is then communicated through the network 12 to the remote communication device 15 for viewing by a third party. In response to this message, the third party communicates a human readable output message “O.K.” from the remote communication device 15 through the network 12 to the remote computer 20. Next, the remote computer 20 converts the human readable output message into a coded output message and communicates this message to the user via output activators on the glove interface assembly 17. In various embodiments, the human readable input and output messages may be text messages, emails or other types of messages and the network 12 may be the Internet.

In another example of the secondary sense communication system and method of operation, the user taps out a coded input message “add 2 plus 2” using the input activators on the glove interface assembly 17, which then transmit the coded input message to the remote computer 20. The remote computer 20 converts the coded input message into a machine readable input message and the requested information is calculated. In response to this message, the remote computer 20 converts a machine readable output message “4” into a coded output message and communicates this message to the user via output activators on the glove interface assembly 17. This type of operation by the secondary sense communication system and method may also apply to time/date requests, mathematical calculation requests, create and type word processing documents, create computer software code, etc.

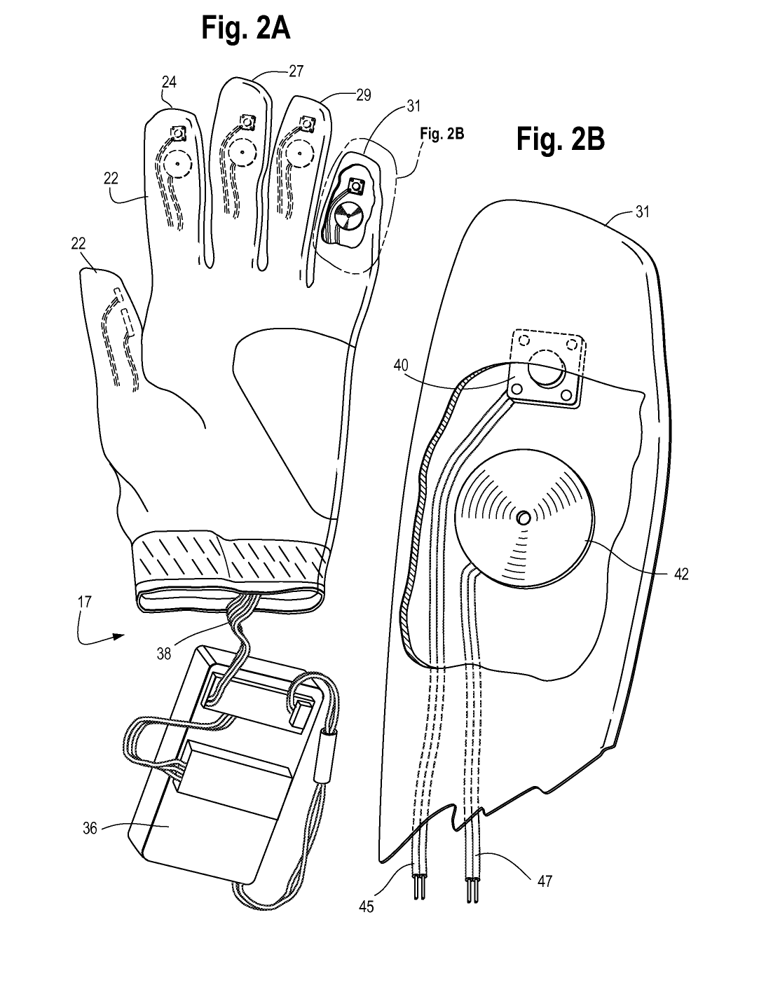

Referring now to FIG. 2A, there is shown in greater detail the glove interface assembly 17 of FIG. 1. The glove interface assembly 17 includes a glove 22 having five digits, digit 24, digit 27, digit 29, digit 31 and digit 33, for a user to wear over the user's four fingers and thumb of one hand. The glove 22 may be configured for either a left or a right hand of the user, depending on the user's preference.

The five digits are functionally similar to each other, and now only digit 31 will be discussed in further detail as shown in an expanded view in FIG. 2B. Digit 31 includes an input activator 40 disposed on or near the fingertip for receiving coded input messages from the user to communicate to the remote computer 20. Digit 31 also includes an output activator 42 disposed on or near the fingertips for receiving coded output messages from the remote computer 20 to communicate to the user.

The glove interface assembly 17 further includes a glove interface controller 36 electrically connected to each of the input activators in each of the five digits of the glove 22 for receiving a coded input message from the user and converting the coded input message into a human readable input message format such as a text message or an email format. The glove interface controller 36 then communicates the human readable input message to a remote communication device 15 via the network 12. In an embodiment, the electrical connections between the glove interface controller 36 and the input activators are shown generally as a bundle of input/output connectors 38 in FIG. 2A and more specifically as input connector 45 in the form of a twisted wire pair connected to input activator 40 in FIG. 2B.

The glove interface controller 36 is also electrically connected to each of the output activators in each of the five digits of the glove 22 for receiving the human readable output message from the remote computer 20 and converting the human readable output message such as a text message or email into a coded output message. The glove interface controller 36 then communicates the coded output message to the user via the output activators. In an embodiment, the electrical connections between the glove interface controller 36 and the output activators are generally shown as input/output connectors 38 in FIG. 2A and more specifically as output connector 47 in the form of a twisted wire pair connected to output activator 42 in FIG. 2B.

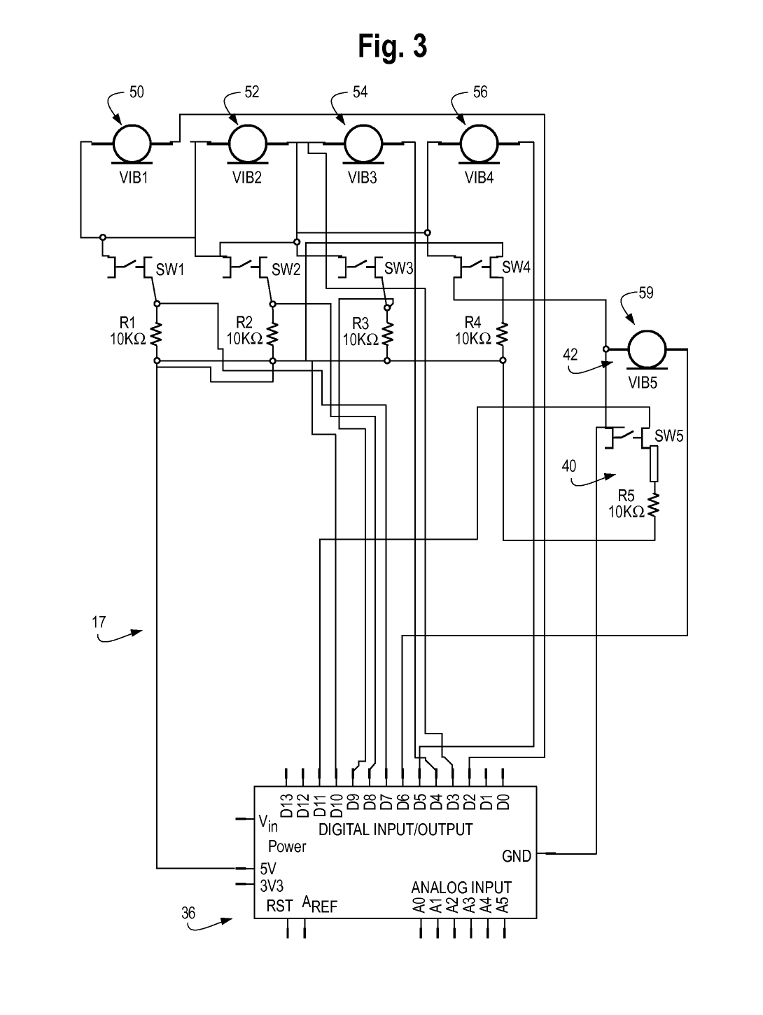

Referring now to FIG. 3, there is shown a schematic illustration of the glove interface assembly 17 of FIGS. 2A-B. Schematically, the glove interface assembly 17 includes five digit activator assemblies: digit activator assembly 50, digit activator assembly 52, digit activator assembly 54, digit activator assembly 56 and digit activator assembly 59. Each of these digit activator assemblies are similar to each other and are associated with one of the five digits on the glove 22 respectfully. As shown schematically, digit activator assembly 59 may include the input activator 40 having a switch and a resistor and the output activator 42 having a vibration device. Also shown is a schematic illustration of the microcontroller 36 in electrical connection with the digit activator assemblies through a series of wires.

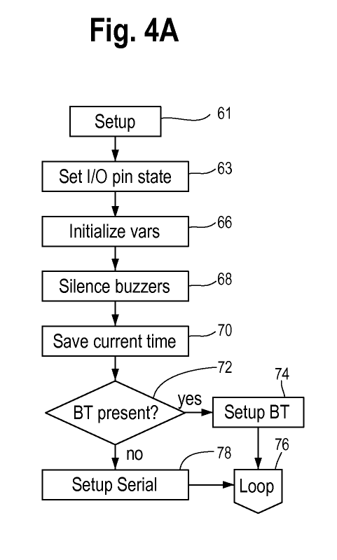

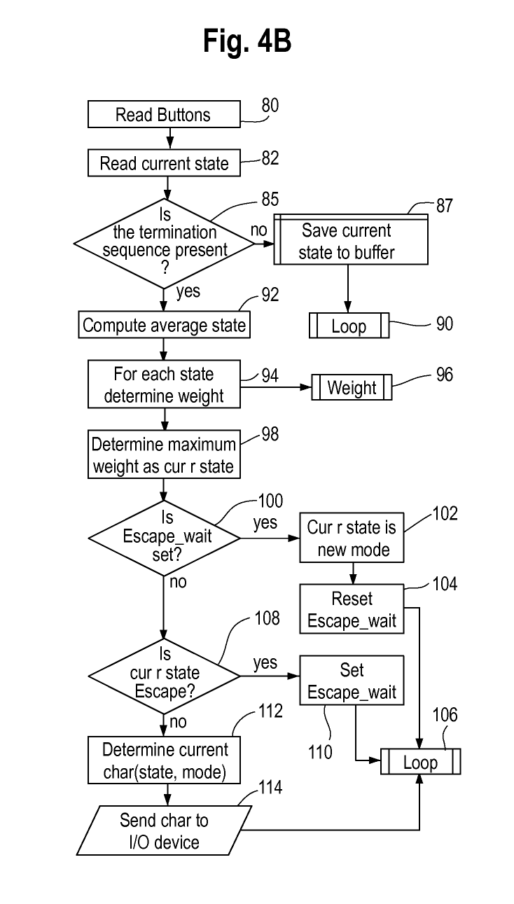

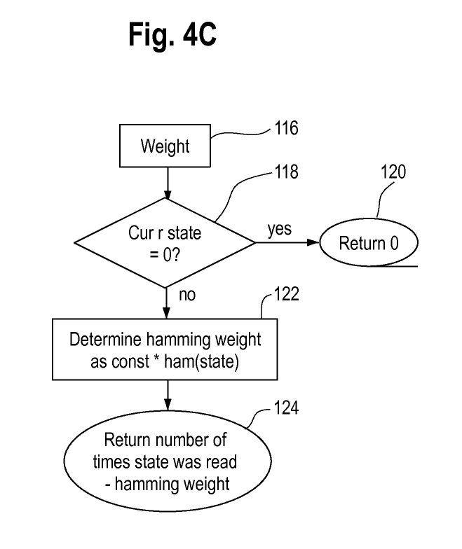

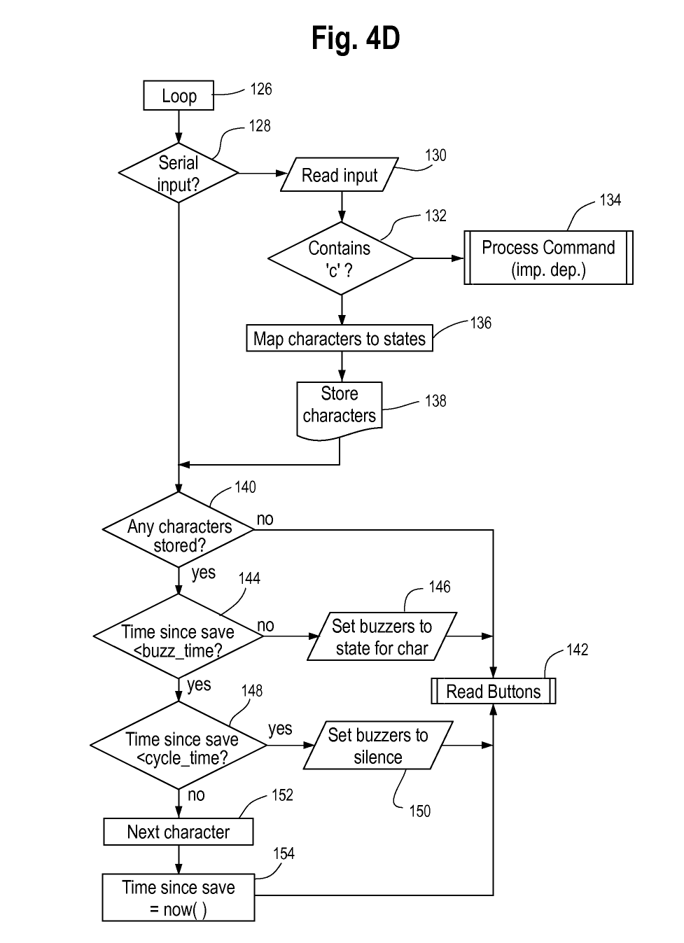

Referring now to FIGS. 4A-D, there is shown a flowchart of the remote computer process for converting coded and human readable messages transmitted between a user and a third party. More particularly, referring now to FIG. 4A, there is shown a flowchart illustrating a setup process for the initialization of the glove interface assembly 17. At Box 61, the setup performs initialization functions that reset the device into a known predetermined state. At Box 63, the glove interface controller software determines the connectivity and functionality of the input/output pins located on the glove interface controller 36. Depending on the type of input activator that are present, pins on the glove interface controller 36 are set for either a digital or analog read mode while pins for the output activators are set for a digital write mode. The glove interface controller software stores the pin information as an internal variable and may be changed as necessary. At Box 66, a series of configuration variables and constants are initialized such as which alphabetic and non-alphabetic character sets to use. Another set of variables are initialized relating to serial communication options, such as the selected Bluetooth identifier, and to communication parameters such as baud rate. At Box 68, because the state of the digital output pins is initially undetermined which may lead to erroneous output activator activation, the digital output pins are cleared. At Box 70, the current time is saved and updated as outputs occur. This is important for the recognition of characters and for their output due to specific time lengths that output activators are activated and deactivated. At Box 72, as a check for one mode of communication, the system determines whether Bluetooth functionality is present via a Bluetooth controller. If Bluetooth functionality is determined to be present at Box 72, the system initializes Bluetooth communication and variables such as baud rate and the Bluetooth identifier and pairing code at Box 74. At Box 76, once the setup sequence is completed, the glove interface controller software call the loop function of FIG. 4D, usually at some predetermined time intervals. At Box 78, if Bluetooth is determined to be not present, the glove interface controller software reverts to serial (wired) communication and determines the related baud rate.

Referring now to FIG. 4B, there is shown a flowchart illustrating a process for reading a user input, starting at Box 80. At Box 82, the state of the input activators is determined. For digital setups, the state is shown by a single byte (i.e., from 0-31 in an example) while in analog setups, a series of five analog values are compared to predetermined threshold values to develop a binary input. At Box 85, the system checks as whether a predetermined termination sequence is present, such as, for example, three subsequent values of zero. At Box 87, if the termination sequence is not present, the state is saved in a temporary buffer. After a termination sequence is identified, this buffer is processed to determine user input. At Box 90, if no terminations sequence is determined, the system returns to the loop sequence. At Box 92, processing the buffer is initiated by determining the average state of the input activators. At Box 94 and at Box 96, the average weight of each state is determined. At Box 98, a specific character is determined based on the average weight. At Box 100, the system determines if an escape sequence has been initiated by the user, such as pressing all digits simultaneously for example. At Box 102, if an escape state was set, the new current state is determined from possibilities such as alphabetic, numeric, symbols or commands. At Box 104, the escape variable input is reset after determining the current state. At Box 106, the system returns to the loop sequence. At Box 108, if the user selected an escape state, the next character selected by the user will determine the next state. At Box 110, if the character input is the escape state, the system sets an escape waiting variable. At Box 112, the system determines a character based on the state and mode selected. For example, if the mode is alphabetic and the state is four, the character “T” is determined. At Box 114, after processing the input signals from the user to determine a character, the character is sent to the output functionality (e.g., serial (wired) or Bluetooth).

Referring now to FIG. 4C, there is shown a flowchart illustrating a process for determining a weighted average of the input activators in order to determine the user's intent of character selection, starting at Box 116. This process improves reliability of the user's intent because of the timing inaccuracies associated with user inputs. In an embodiment, the system calculates a Hamming weight for determining the state based on the number of input activators activated by the user with preference given to states associated with higher numbers of activations. At Box 118, the weight of the “O” state is set at zero and is returned at Box 120. At Box 122, a constant is used to determine the amount of offset that adjusts the state based on the Hamming weight. The constant and calculation used are related to the specific command sequence implementation. At Box 124, the number of times a state was read is added to the Hamming weight and returned.

Referring now to FIG. 4D, there is shown a flowchart for the loop functionality which is called after completion of the setup function of FIG. 4A. At Box 126, the loop sequence is called by the remote computer software. At Box 128, the remote computer software determines whether any input such as characters or commands have been sent by the glove interface controller software. In addition, the remote computer software may also determine the state of the serial port for both the Bluetooth and the wired implementations. At Box 130, the serial input is read by the read( ) functionality in the serial software interface. At Box 132, a check is made for a lowercase “c” which would indicate a command sequence. At Box 134, if a command sequence is indicated, the sequence is transmitted to the glove interface controller software for execution of various commands such as resetting a buffer, increasing or decreasing output speed, or changing PIN states. At Box 136, each character is mapped to a specific state of the output activators. At Box 138, translated characters are read and stored in a buffer for presentation to the user via the output activators. At Box 140, the system checks for any stored characters in the buffer.

At Box 142, the system reads any user input via the input activators. At Box 144, an output of characters is presented to the user via the output activators in a predetermined timing sequence including a silent period after each state. At Box 146, if the time since save is less than the activation time for the output activators, then the output activators are set to the state indicated in the buffer. At Box 148, the system checks to determine if the cycle time (total time between characters) is greater than the activation time. At Box 150, after the activation time is determined to be completed, the output activators are set to a deactivated state to alert the user that a character has been completed, which may increase the accuracy of character detection by the user. At Box 152, the system proceeds to the next character. At Box 154, the current time is saved to initialize the starting sequence for the next character.

### Hardware

The shell of the secondary sense communication system 10 consists of the glove 22 into which the components of the system are woven or glued. Input from the user is realized using input activators in the form of tactile button switches placed on the fingertips of the glove 22. Output stemming from the remote computer 20 is presented to the user by output activators in the form of vibrations, typically generated using a vibration device in the form of a buzzer.

The glove 22 provides one input activator and one output activator per finger, including the thumb. The wiring of the input activators and the output activators is connected to the glove interface controller 36 in the form of a processing unit or a glove interface controller. The glove interface controller 36 measures the pressing of the input activators and translates it into characters according to an algorithmic table. The glove interface controller 36 also receives the output from the remote computer 20 and translates it to a series of vibrations.

The glove interface controller 36 may be further equipped with a connection module (not shown) that allows it to interface with the remote computer 20. This connection module may be wired or wireless, where the wireless option is preferred and may be in the form of a Bluetooth controller.

### Encoding

For speed of communication, the secondary sense communication system and method uses parallel transmission of codes between the user (glove wearer) and the remote computer 20 so that the user can press one or more input activators for each character. Similarly, each character transmitted from the remote computer 20 is translated back to the user using parallel vibrations on multiple fingers.

The input activators and the output activators have an on and off setting, thus providing a 5-bit (one per finger) bi-directional code. The term bit means the equivalent of a pressing or vibration of a single finger, while the term state refers to the set of values for all five bits.

The encoding used to represent the various characters may consider several factors and rules. First, a smaller number of bits are generally easier to type and recognize than a larger number. Second, the character set required is larger than the number of states available (5 bits=2⁵=32 states available). Third, when an entire character set is split into two or more partial sets, those partial sets may be consistent with each other. Fourth, because the null state (no fingers pressed) is indistinguishable from the pause between characters, this state is not available for the encoded system. Fifth, transitions between partial sets of characters may occur using an escape state, which is a single state (of pressing or vibration) that corresponds to a shift in a partial character set. Sixth, because some states are hard to distinguish (such as similar two-bit and three-bit states using the same fingers), those states should be mapped to characters with largely overlapping meaning (e.g., the letters q and k which consistently sound the same in the English language). Seventh, because it is desirable for new users to distinguish between different states, a logical organization of easily memorized letters may make this learning process easier. Eighth, because user preferences for different languages or uses may create a need to make the details of the encoding flexible, the system may deviate from its default encoding to one selected by the user.

The first factor above describes how the letter frequency in the default language of the secondary sense communication system and method may be taken into account to allocate mapping of the letters. For example, when using English as the default encoding language, the letter frequency is generally unrelated to the position in the alphabet. More particularly, the letters tend to cluster around several groups: Space (i.e., no character) and e: extremely frequent; t, a, o, l, n, s, h, r: frequent; d, l: average; c, u, m, w, f, g, y, p: less frequent; b, v, k: infrequent; and j, x, q, z: extremely infrequent.

For the assignment of the letter encoding, letters that occur more frequently are assigned states that are more easily distinguished, which are generally those states with fewer digit activations. Letters that occur less frequently may be mapped to states that are less easily distinguished, so that any confusion with another letter is with a letter than may be similar in some aspect such as sound (e.g., k and q).

Given that neither the letter frequency nor the ease of confusion of different states is statically defined, an initial assignment may be made according to arbitrary factors such as ease of learning.

### Characters in the Letter Character Set

In an embodiment, in addition to the often-used Space, Escape and null states, the letter character set may correspond to the 26 letters of the English alphabet. Thus, in this embodiment, 29 out a possible 32 states are employed with 3 remaining unused states. In addition, a unified punctuation mark may receive its own state for ease of entering.

Some letters may be unified, since they have little stand-alone importance. For example, the letters k and q are consistently pronounced the same and may be unified.

TABLE 1 illustrates a coding for character set for the English language according to an embodiment. As shown in TABLE 1, the letters A-Z and the characters space and apostrophe/punctuation are found on the left side, while digits P (Pinky), R (Ring), M (Middle), I (Index) and T (Thumb) are found on the top. A digit being activated is indicated by an “ON” in the table while a digit not being activated is shown by an “OFF” in the table. This digit activation character set code may apply to both the input activators and the output activators.

TABLE 1

| Symbol | P | R | M | I | T |
|---|---|---|---|---|---|
| Space | OFF | OFF | OFF | OFF | ON |
| E | OFF | OFF | OFF | ON | OFF |
| T | OFF | OFF | ON | OFF | OFF |
| O | OFF | ON | OFF | OFF | OFF |
| A | ON | OFF | OFF | OFF | OFF |
| I | OFF | OFF | OFF | ON | ON |
| N | OFF | OFF | ON | ON | OFF |
| S | OFF | ON | ON | OFF | OFF |
| H | ON | ON | OFF | OFF | OFF |
| R | OFF | OFF | ON | OFF | ON |
| D | OFF | ON | OFF | ON | OFF |
| L | ON | OFF | ON | OFF | OFF |
| C | ON | OFF | OFF | OFF | ON |
| U | OFF | ON | OFF | OFF | ON |
| M | ON | OFF | OFF | ON | OFF |
| F | OFF | OFF | ON | ON | ON |
| G | OFF | ON | ON | ON | OFF |
| W | ON | ON | ON | OFF | OFF |
| Y | ON | OFF | ON | OFF | ON |
| V | OFF | ON | ON | ON | ON |
| P | ON | ON | ON | ON | OFF |
| B | ON | ON | OFF | ON | ON |
| Z | OFF | ON | ON | OFF | ON |
| Q | ON | ON | OFF | OFF | ON |
| J | ON | OFF | ON | ON | OFF |
| X | OFF | ON | OFF | ON | ON |
| K | ON | OFF | OFF | ON | ON |
| Apostrophe/ | ON | ON | ON | OFF | ON |
| Punctuation | | | | | |

### Other Partial Character Sets

Aside from the main character set, other character sets that may be employed including numbers and symbols used in mathematics, punctuation marks and symbols, letter modifiers, accents, marks and commands. As discussed above, some of the characters in these sets overlap such as both the math set and the punctuation marks set include parentheses. Therefore, overlapping characters may be mapped to overlapping states.

Considerations for Languages Other than English

The same logic used to determine the state table for English may be used for other languages. The steps to find the correct translation table consists of: (1) Determine the total number of characters in the language; languages with more than 26 (or 28) letters may define some additional encoding. (2) Determine letter frequencies in the language, possibly using widely available reference sources. (3) Map more frequently used letters to activation combinations that are easier to manipulate.

### Software

In an embodiment, the software that controls the secondary sense communication system and method may comprise two components: glove interface controller software associated with the glove interface controller 36 and driver software associated with the remote computer 20.

In general, the glove interface controller software controls the input activators and the output activators. Further, the remote computer software processes and converts a coded message input signal into a human readable text input signal and transmits to a third party via the network 12. The remote computer software also receives a human readable text output signal from a third party via the network 12 and processes and converts this signal into a coded message output signal for transmission to the glove interface controller 36.

### Glove Interface Controller Software Input

The glove interface controller software registers the activation of the input activators by a user and encodes this activation as shown in an embodiment in TABLE 1. Since humans may not be able to precisely time independent input activators, the glove interface controller 36 effectively measures each state by measuring its input over time to derive a most likely state activated. This most likely state is then transmitted to the remote computer 20.

To determine the most likely state, the glove interface controller measures the Hamming weight of the state (the number of input activators activated) in order to determine which momentary state is selected. The state with the most input activators activated is determined to be the most likely state, provided this state has been held for a sufficient (minimum) amount of time.

The glove interface controller software may also process escape sequences. An escape sequence entered by the user is not transmitted directly to the remote computer software, but first is internally processed by the glove interface controller software and the result of such processing is transmitted.

### Glove Interface Controller Software Output

The output coded message signal transmitted from the remote computer 20 to the glove interface assembly 17 is presented to the user as a state of the output activators, and may be in the form of one or more vibrations as shown in an embodiment in TABLE 1. Output activation states are held for a period commensurate to each user's ability to process information, and then the output activator is turned off to mark the end of the character. The duration of the output activation versus no-activation states may be dependent on user preferences. A buffer in the secondary sense communication system 10 may allow the user to repeat the last line of input, using an input escape sequence.

### Glove Interface Controller Software Settings

The remote computer software and the command sequences in the corresponding partial character set may be used to set parameters of the glove interface controller software. Such parameters may include the following:
1. Accelerating and decelerating output.
2. Bit reassignment (for example, may be employed for mirroring such when the glove interface assembly 17 is switched to a user's other hand or for certain types of physical limitations).
3. Alphabet reassignment.
4. Switching to and from “raw” mode, in which the glove interface controller software does not interpret input activator activations and simply transmits such activators directly to the remote computer software.

### Driver Software

In systems capable of using the secondary sense communication system and method as a complete input/output system, the remote computer software may be a system driver. For example, this may apply to terminals with no graphics capabilities, such as certain UNIX systems. In this case, the remote computer software will include a series of functions tailored to connecting the functionality of the remote computer operating system to the secondary sense communication system 10.

The remote computer software, when not functioning as a system driver, may choose to define a series of available shortcuts and advertise them to the user. Such shortcut functionality may include text messaging, web searches (including custom searches), utility functions (e.g. calculator), help, etc. The remote computer software may also include ‘hooks” for external applications to advertise services that can be downloaded after the remote computer software is installed.

### Example

### Sending and Receiving a Text Message

As an example communication, Alice wants to send Joe a text message the secondary sense communication system and method. She would enter the following using the input activators on the glove interface assembly 17:
M: JOE: THE QUICK BROWN FOX

In this example, the initial letter M marks a message to be sent. This letter is followed by the general punctuation mark (the colon used here is simply for clarification), the name of the recipient and the message. The remote computer software processes this coded input message into a human readable text input message, uses the remote computer operating system to identify contact information matching the name JOE, and send the message to Joe via the identified contact information.

Once a reply is received from Joe, the remote computer software (registered as a recipient for text messages with the operating system) alerts the user to the presence of a message using an “alert” state sequence. Once the user replies with an acknowledgment, the secondary sense communication system and method transmits to the user via the output activators a coded input message such as:
MESSAGE FROM JOE: JUMPS OVER THE LAZY DOG

The formatting of the reply is mainly user-dependent. For example, this reply is fairly verbose, unlike the terse sequence in the output. This is because, in general, users prefer shorter input sequences for commands, and longer output sequences.

### Additional Uses

While the input function makes use of a mapping the bits to characters in a defined set, a series of additional uses may require the translation to occur in the glove interface assembly 17. In this case, the glove interface assembly 17 may switch to a “raw” mode, in which current readings of the input activators are sent to the remote computer software in an unfiltered mode and at an adjustable speed (usually a maximum speed as agreed to by both sides, but not to exceed the speed of the connection between the two components).

### Authentication

The input of a password in the raw mode may extend the functionality of a generic password by measuring the typical state sequence and matching its fingerprint with one stored for a specific user. This fingerprint may be stored on the remote computer 20, or in an external location to which the fingerprint is sent for verification.

This form of verifying passwords is difficult to decode by unauthorized third parties because the timing of bit changes has to be known. Because different users input characters at different speeds, even the input of a single character may occur using replicable sequences of states that are unique to each user. This is because a user is not usually able to press all of the input activators at the same time and the sequence in which the input activators are pressed may define a characteristic for each user.

### Precision Control

Where there is a need for precision control, as might be the case to steer a cursor/pointer or to play a game, the secondary sense communication system and method can communicate states to compatible software.

For example, a mouse driver for graphical operating systems may map four bits to the cardinal directions and the fifth bit to a mouse button. Additionally, a game may assign particular meaning to any state. The system driver may also interface with other external software by mapping between the secondary sense communication system 10's output and the external software's input.

### Device Implementation

The glove may be constructed from a material that does not collect moisture, which may damage the electronic components. In an embodiment, a standard golf glove may be chosen because the material is meant to be worn over extended periods of time while it breathes and wicks moisture away. Also, golf gloves are typically left-handed, and for many wearers this may be a better choice than the dominant right hand to keep the right hand free for other duties.

### Digit Electronics

Each finger in the glove 22 needs to contain circuitry and components for the input and the output activators. In an embodiment, the input activator 40 may comprise a tactile switch, such as the TE Connectivity 3-1437565-0. The output activator 42 may comprise a vibration motor, such as the Parallax 28821.

Depending on the type of input activator used, connections may be made from the input activators to common ground (GND), the power supply (typically +5V) and a digital input pin, or, in another embodiment, just from the digital input pin to common ground. The vibration motor may require connections to ground and a digital output pin. All connections to ground are collected from each finger into a common ground wire that may be connected to the GND pin of the glove interface controller 36. All connections to the power supply are to be collected in a similar way and connected to the power supply (typically +5V) on the glove interface assembly controller 36.

The input activator may be placed on each finger in a position that is easily actuated. Typically, this is the tip of the finger, where the input activator will function in a way similar to keys on a keyboard. However, the input activator may be placed on any point on the palm side of the finger, provided the user is able to push the input activator comfortably. The output activator may also be placed on any point of the finger. Placement near the tip of the finger may ensure maximum amount of sensation since the tips are the most sensitive portion of the finger.

The input activator and the output activator in each finger, as well as the wires leading to and from the activators, may be protected from wear with a coating such as plastic or rubber. Often, much of this wear may be due to sliding the glove on or off a human hand. Wires are not required to be shielded or protected from interference since the signal traveling on them is at a low frequency (<10 Hz). Also, since the currents are relatively small, an implementation may choose many available types of wire, including sewable wire, as long as the wire is sufficiently thin and flexible so as not to present resistance to the wearer.

### Glove Interface Controller

The input and output of the finger electronics may comprise 10 digital Input/Output (I/O) pins of the glove interface controller 36. A standard multiplexer unit may be added to reduce the number of I/O pins if required.

In an embodiment, the glove interface controller 36 may comprise a microcontroller such as an Arduino Pro Micro having sufficient I/O pins and a small form factor. This Arduino board is configured around an ATmega32U4 microcontroller and provides 12 digital I/O pins, direct USB connectivity (using an on-board, standard micro-USB connector) and digital R,X and TX lines for Bluetooth connectivity.

### Bluetooth Controller

In an embodiment, the Bluetooth controller may be separated from the main glove interface controller to allow design flexibility. Several vendors provide off-the-shelf Bluetooth controllers that allow direct serial communication using the R,X and TX pins on standard microcontroller boards. These Bluetooth controllers may replace a wired serial connection and typically require their own microcontroller for translation purposes. One such Bluetooth controller is the Virtuabotix BT2S-slave, which converts any Arduino board with available TX and R,X lines into a Bluetooth-capable board.

To connect the Bluetooth-to-serial controller board, the R,X and TX lines of the glove interface controller 36 (Arduino) board may be connected to the corresponding lines on the Bluetooth controller. In addition, the power and ground lines may be connected to the corresponding lines on the glove interface controller 36 (Arduino) board.

### Power Supply

The Arduino Pro Micro may be supplied with power via the on-board Micro-USB port or through dedicated power pins on the board. In an embodiment that is not connected to the remote computer 20 via wires, the latter is preferable since the external power supply pin on the board is regulated and may accept a variety of input voltages. Because these two boards require a fairly large amount of current in this configuration, the power supply may consist of a single 9V block battery.

### Connections

All connections may be soldered using commercially available solder.

### Computer/Phone

Typically, no modifications are required to the hardware of a remote computer 20 or a phone connected to the glove interface assembly 17. For connectivity, these devices may provide either a USB master port, to which the glove may be connected using a cable, or a Bluetooth controller, to which the glove interface assembly 17 may be connected using a wireless connection.

### Vibration Motors (Output Actuators)

In an embodiment, a Parallax 28821 vibration motor may be employed as an output actuator or even thinner components may be employed.

### Input Actuators

One embodiment of the input activators makes use of tactile push-button input activators having a defined “click” upon activation (i.e., pressing). Having this click feature can aide in debugging issues and provide the user with clear feedback from a push on the input activator.

Another embodiment may employ input activators having a touch-sensing click by using a pressure sensor. Use of a touch-sensing input activator may obtain a range of values instead of a binary output which may factor into the decision regarding which state was activated (pressed).

For this calculation where the pressure applied may be mapped to a pressed state, a user may determine initial calibration maximal levels by pressing each input activator by itself. A data table may then map the typical pressure applied to each finger in any given state as a percentage of the maximum value and then factor this weight into the state computation.

### Glove Interface Controller Electronics

In an embodiment, the glove interface controller 36 may be combined with a Bluetooth controller. Both controllers may be housed on the same circuit board and the Bluetooth controller software integrated with the glove interface controller software.

This combined configuration has several advantages:
1. The combined circuit uses lower power than separate boards. In particular, using a low-power Bluetooth chip may reduce the power use considerably.
2. A smaller power supply, typically a battery, may make regular use less burdensome for the user.
3. The reduced size and weight may make fewer demands on the strength of the supporting glove and enable a more lightweight approach to the sensors.

### Glove

In various embodiments, factors for the glove 22 may include ease of wearing (since the glove may be worn for long stretches of time), durability, light weight, and the protection of electronic components (since the glove may encounter water, cold, heat, sunlight, etc.).

Because the glove 22 supports the electronic components for each finger, the fingers may be connected to a central hub where the glove interface controller 36 resides. Locations for the hub may be the back of the hand or the wrist.

In one embodiment, the glove 22 is similar to a sports glove such as a golf glove. In this example, the inner liner of the glove 22 protects the electronics from the fingers while the outer shell protects the electronics from the elements. The placement of input and output activators may depend on the level of familiarity of the user. For example, beginners may employ a glove 22 that have input and output activators located at or near the tip of the fingers, since those are their most sensitive parts. In addition, advanced users may employ a glove 22 that have input and output activators located at or near the lower phalanges, since this location is sufficient for their advanced proficiency level. This configuration leaves the more sensitive parts of the finger (the tips) available to use for other tasks. In this embodiment, the glove interface controller 36 may be placed on the back of the hand.

### Modified Glove

In another embodiment, instead of a full glove, rings bearing the input and output activators may be placed on the fingers at a location chosen by the wearer, while wires would lead from these rings to a glove interface controller 36 hub (not shown). In addition, the placement of the rings at the tip of the finger or at the lower phalanges applies as discussed in the section above. The placement of the hub, containing the glove interface controller 36, may be on the back of the hand or in a wrist-mounted device that may also function as a regular (smart) watch.

While particular embodiments have been disclosed, it is to be understood that various different modifications and combinations are possible and are contemplated within the true spirit and scope of the disclosed embodiments. There is no intention, therefore, of limitations to the exact disclosure herein presented

What is claimed is:

1. A computer interface system, the system comprising:
a glove having one or more digit components each having an input activator for receiving a coded input signal from a wearer of the glove and an output activator for transmitting a coded output signal to the wearer of the glove;
a control unit connected to each of the input activators and the output activators for receiving from the input activators and transmitting to a remote computer the coded input signal and for receiving from the remote computer and transmitting to the output activators the coded output signal;
a power source connected to the control unit and each of the input activators and the output activators for providing power; and
wherein the remote computer converts the coded input signal into a machine readable text input signal and converts a machine readable text output signal to the coded output signal for transmitting to the control unit.

2. A system according to claim 1, wherein the input activator is a button switch.

3. A system according to claim 1, wherein the output activator is a vibration device.

4. A system according to claim 1, wherein the control unit further includes a wireless communication component for transmitting the coded input signal and receiving the coded output signal wirelessly.

5. A method of communicating with a computer, the method comprising:
receiving a coded input signal from a wearer of a glove;
transmitting the coded input signal to a remote computer;
converting the coded input signal into a machine readable text input signal;
processing the machine readable text input and creating a machine readable text output signal;
converting the machine readable text output signal into a coded output signal;
transmitting the coded output signal to the glove; and
transmitting the coded output signal to the wearer of the glove.

6. A method according to claim 5, wherein the step of receiving a coded input signal from a wearer of a glove further includes receiving the signal via a button switch.

7. A method according to claim 5, wherein the step of transmitting the coded output signal to the wearer of the glove further includes transmitting the signal via a vibration device.

8. A method according to claim 5, wherein the steps of transmitting the coded input signal to a remote computer and transmitting the coded output signal to the glove further include transmitting the signals wirelessly.

9. A method of communicating through a network, the method comprising:
receiving a coded input signal from a wearer of a glove;
transmitting the coded input signal to a remote computer;
converting the coded input signal into a human readable text input signal; and
transmitting the human readable text input signal to a third party via the network.

10. A method according to claim 9, wherein the step of receiving a coded input signal from a wearer of a glove further includes receiving the signal via a button switch.

11. A method according to claim 9, wherein the step of transmitting the coded input signal to a remote computer further include transmitting the signals wirelessly.

12. A method according to claim 9, wherein the network is the Internet.

13. A method according to claim 9, wherein the human readable text input signal is an email.

14. A method according to claim 9, wherein the human readable text input signal is a text message.

15. A method of communicating through a network, the method comprising:
receiving a human readable text output signal from a third party via the network;
converting the human readable text output signal into a coded output signal;
transmitting the coded output signal to a glove; and
transmitting the coded output signal to a wearer of the glove.

16. A method according to claim 15, wherein the step of transmitting the coded output signal to a wearer of a glove further includes transmitting the signal via a vibration device.

17. A method according to claim 15, wherein the step transmitting the coded output signal to a glove further include transmitting the signal wirelessly.

18. A method according to claim 15, wherein the network is the Internet.

19. A method according to claim 15, wherein the human readable text output signal is an email.

20. A method according to claim 15, wherein the human readable text output signal is a text message.

21. A method of coding and decoding language characters and functions for touch-enabled communication, the method comprising,

| Symbol | P | R | M | I | T |
|---|---|---|---|---|---|
| Space | OFF | OFF | OFF | OFF | ON |
| E | OFF | OFF | OFF | ON | OFF |
| T | OFF | OFF | ON | OFF | OFF |
| O | OFF | ON | OFF | OFF | OFF |
| A | ON | OFF | OFF | OFF | OFF |
| I | OFF | OFF | OFF | ON | ON |
| N | OFF | OFF | ON | ON | OFF |
| S | OFF | ON | ON | OFF | OFF |
| H | ON | ON | OFF | OFF | OFF |
| R | OFF | OFF | ON | OFF | ON |
| D | OFF | ON | OFF | ON | OFF |
| L | ON | OFF | ON | OFF | OFF |
| C | ON | OFF | OFF | OFF | ON |
| U | OFF | ON | OFF | OFF | ON |
| M | ON | OFF | OFF | ON | OFF |
| F | OFF | OFF | ON | ON | ON |
| G | OFF | ON | ON | ON | OFF |
| W | ON | ON | ON | OFF | OFF |
| Y | ON | OFF | ON | OFF | ON |
| V | OFF | ON | ON | ON | ON |
| P | ON | ON | ON | ON | OFF |
| B | ON | ON | OFF | ON | ON |
| Z | OFF | ON | ON | OFF | ON |
| Q | ON | ON | OFF | OFF | ON |
| J | ON | OFF | ON | ON | OFF |
| X | OFF | ON | OFF | ON | ON |
| K | ON | OFF | OFF | ON | ON |
| Apostrophe/ | ON | ON | ON | OFF | ON |
| Punctuation | | | | | |
